(19) United States
(12) Patent Application Publication
(10) Pub. No.: US 2024/0370009 A1
(43) Pub. Date: Nov. 7, 2024

(54) JOINT TRAINING METHOD FOR PREDICTING REMAINING USEFUL LIFE OF INDUSTRIAL SYSTEMS USING TIME-SERIES DATA

(71) Applicants: Iowa State University Research Foundation, Inc., Ames, IA (US); Percev LLC, Davenport, IA (US)

(72) Inventors: Venkat Pavan Nemani, Ames, IA (US); Chao Hu, Sudbury, MA (US); Carey E. Novak, Ames, IA (US); Andrew T. Zimmerman, Bettendorf, IA (US)

(73) Assignees: Iowa State University Research Foundation, Inc., Ames, IA (US); Percev LLC, Davenport, IA (US)

(21) Appl. No.: 18/650,867

(22) Filed: Apr. 30, 2024

Related U.S. Application Data
(60) Provisional application No. 63/499,909, filed on May 3, 2023.

(51) Int. Cl. G05B 23/02

(52) U.S. Cl. CPC G05B 23/0283; G05B 23/0281

(57) ABSTRACT

A method for using time-series data to predict remaining useful life of industrial equipment in cases where limited time-series training data is available is described. The method includes steps of monitoring the industrial equipment to sense historical time-series data associated with the industrial equipment using at least one sensor, storing the historical time-series data from the at least one sensor, accessing the historical time-series data and pre-processing the historical time-series data to extract higher-level features associated with the remaining useful life of the industrial equipment, and applying a jointly trained health predictor to the higher-level features using a computing device by executing a set of instructions from a non-transitory machine readable memory using a processor of the computing device to determine a prediction for the remaining useful life of the industrial equipment.

### RELATED APPLICATIONS

This application claims priority to U.S. Provisional Application No. 63/499,909, filed May 3, 2023, hereby incorporated by reference in its entirety.

### STATEMENT OF GOVERNMENT SUPPORT

This invention was made with Government support under grant/contract no. IIP2036044 awarded by the National Science Foundation. The government has certain rights in this invention.

### FIELD OF THE INVENTION

The present disclosure relates to predicting the future behavior such as remaining useful life of industrial equipment. More particularly, but not exclusively, the present disclosure relates to a machine learning model for producing an explainable prediction of the remaining useful life of industrial equipment.

### BACKGROUND

Industrial systems and equipment that manage processes such as manufacturing processes are often relied upon to work flawlessly twenty-four hours per day, seven days per week. Unfortunately, because of the potentially harsh physical environments and uncontrollable outside factors that are present in any industrial ecosystem, most subcomponents in any industrial system are subject to expensive failure.

In one example, machines in the industrial environment are often subject to degradation from both long-term use and from periodic overloading. This type of machine degradation often leads to equipment failures that can compromise worker safety, cause production delays, and force expensive repairs or replacements. One way to avoid such costs is to perform maintenance prior to failure, but this often requires being able to predict when failure will occur.

Issues with supply chains may further amplify issues associated with failures of industrial equipment where replacement parts are needed. One way to avoid such costs is to proactively increase inventory levels of hard-to-obtain replacement components, but doing so may be costly. Such issues may be attenuated if accurate predictions of failures could be made.

In industrial systems, there have been many attempts made at predicting failure. These attempts typically rely on historical sets of time-series data to train a machine learning model that can predict the future behavior of the industrial system including the remaining useful life of industrial equipment or components thereof. However, such attempts have mostly proven to suffer from inaccuracies and other problems. First, because of the inherent variability present in the industrial environment, there is often an insufficient amount of accurate time-series data to train an effective predictive model. Second, even in the case where a model makes an accurate prediction, machine learning models are often distrusted because they provide “black-box” type predictions without context or explainability. Third, overly conservative predictions can often be worse than no prediction at all because they have the potential to prematurely encourage costly actions that, in the end, outweigh the costs of the failures they are predicting.

### SUMMARY

Therefore, it is a primary object feature, or advantage of the present disclosure to improve over the state of the art.

It is a further object, feature, or advantage of the present disclosure to provide effective failure prediction in industrial equipment to reduce downtime.

It is a still further object, feature, or advantage of the present disclosure to minimize repair costs in industrial equipment.

Another object, feature, or advantage of the present disclosure to increase worker safety.

Yet another object, feature, or advantage of the present disclosure is to provide methods and systems for preventative maintenance that do not require large training datasets which are difficult if not impossible to generate.

A further object, feature, or advantage is to provide context alongside failure predictions.

A still further object, feature, or advantage is to provide failure predictions which are considered trustworthy.

Another object, feature, or advantage is to avoid conservative predictions which cause unnecessary maintenance.

Yet another object, feature, or advantage is to avoid overly aggressive predictions which do not always prevent downtime.

A further object, feature of advantage is to use physics-inspired models to allow for predictions to be made with either reduced or non-existent training datasets.

A still further object, feature, or advantage is to provide risk-based or probabilistic predictions which allows users to leverage context to make better decisions.

Another object, feature, or advantage is to provide explainable or “non-black-box” predictions which assist users in interpreting predictions without their own intuition such as to assist them in answering, “Why a certain prediction is made” and/or “What triggered this failure mode”.

Yet another object, feature, or advantage is to provide an approach that may be applied to any complex piece of industrial equipment including rolling element bearings.

A still further object, feature, or advantage is to provide methods that may be applied within Industrial Internet-of-Things (IIoT) devices.

Another object, feature, or advantage is to provide methods which use deep learning (DL) to predict failures without requiring heavy computing resources.

Yet another object, feature, or advantage is to provide methods which may be used in embedded systems such as in self-contained sensor units which may be battery powered.

One or more of these and/or other objects, features, or advantages of the present disclosure will become apparent from the specification and claims that follow. No single aspect need provide each and every object, feature, or advantage. Different aspects may have different objects, features, or advantages. Therefore, the present disclosure is not to be limited to or by any objects, features, or advantages stated herein.

According to one aspect, a method for using time-series data to predict the future behavior of an industrial system in cases where limited time-series training data is available is provided. The method includes monitoring the industrial system to sense historical time-series data associated with the industrial system, storing the historical time-series data from the at least one sensor, and accessing the historical time-series data and pre-processing the historical time-series data to extract higher-level features associated with future behavior of the industrial system. The method further includes applying a jointly trained health predictor (HP-JT) to the higher-level features using a computing device by executing a set of instructions from a non-transitory machine-readable memory using a processor of the computing device to determine a prediction for the future behavior of the monitored system. In some embodiments, the future behavior of the industrial system may be remaining useful life (RUL) of a part within the industrial system.

According to another aspect, a method for using time-series data to predict remaining useful life of industrial equipment in cases where limited time-series training data is available is described. The method includes steps of monitoring the industrial equipment to sense historical time-series data associated with the industrial equipment using at least one sensor, storing the historical time-series data from the at least one sensor, accessing the historical time-series data and pre-processing the historical time-series data to extract higher-level features associated with the remaining useful life of the industrial equipment, and applying a jointly trained health predictor (HP-JT) to the higher-level features using a computing device by executing a set of instructions from a non-transitory machine readable memory using a processor of the computing device to determine a prediction for the remaining useful life of the industrial equipment. The jointly trained health predictor (HP-JT) may be trained using real data and augmented with generated data. The generated data may be generated using a Generative Adversarial Network (GAN). The jointly trained health predictor (HP-JT) may include a neural network layer. The neural network layer may be a long short-term memory (LSTM) layer. The industrial equipment may include industrial mechanical equipment and the time-series data may include machine sensor data collected from at least one sensor. The industrial equipment may include a bearing such as a roller element bearing. The sensor data may include data such as shaft rotation speed and loading conditions associated with a roller element bearing. The sensor data may include vibration data and the at least one sensor comprises an accelerometer. A sensor module may include the at least one sensor, the computing device, and the non-transitory machine-readable memory and may be configured for performing the method. The sensor module may further include a battery disposed within the housing with the sensor module is powered by the battery.

According to another aspect, a sensor module for predicting remaining useful life of industrial equipment in an industrial environment is provided. The sensor module includes sensor housing, a processor disposed within the sensor housing, and at least one sensor for sensing machine data for the industrial equipment, the at least one sensor operatively connected to the processor. The processor is configured to extract higher-level features associated with the remaining useful life of the industrial equipment from the machine sensor data and apply a jointly trained health predictor (HP-JT) to the higher-level features using a computing device by executing a set of instructions from a non-transitory machine-readable memory using a processor of the computing device to determine a prediction for the remaining useful life of the industrial equipment. The jointly trained health predictor (HP-JT) may be trained using physically acquired data and augmented with generated data. The generated data may be generated using a Generative Adversarial Network (GAN). The jointly trained health predictor may include a neural network layer which may be a long short-term memory (LSTM) layer. The industrial equipment may include a bearing such as a roller element bearing. The machine data may include vibration data and the at least one sensor may include at least one accelerometer for sensing the vibration data.

### BRIEF DESCRIPTION OF THE APPENDIX

Attached as an appendix is a paper entitled “Joint training of a predictor network and a generative adversarial network for time series forecasting: A case study of bearing prognostics” which forms a part of this disclosure.

### BRIEF DESCRIPTION OF THE DRAWINGS

Illustrated aspects of the disclosure are described in detail below with reference to the attached drawing figures, which are incorporated by reference herein.

FIG. 1 illustrates the main components and flow chart outlining the steps for preparing data for training a predictor and then using that data to perform offline training of that predictor.

FIG. 2 illustrates a flow chart outlining the steps for online remaining useful life forecasting.

FIG. 3 shows an example of a higher-level feature over time where as time advances from a first prediction time (T_{FTP}) until an end-of-prediction (EOP) threshold is met at an EOP time (T_{EOP}).

FIG. 4 illustrates the steps of pre-training a predictor, pre-training a generator and discriminator, and jointly training a predictor, generator, and discriminator in more detail. Dashed lines represent the backpropagation of loss values.

FIG. 5 provides a summary of the generated signals used in Case Study 1 with (a) quadratic and (b) three-stage degradation behavior.

FIG. 6 illustrates RMSE_{All} results from Case Study 1 by multiple methods under different training settings; (a) the total training epoch=50, the HP-JT was pre-trained with 30 epochs, and the joint training took 20 epochs (b) the total training epoch=200, the HP-JT was pre-trained with 30 epochs and the joint training of 170 epochs.

FIG. 7 illustrates predicted results from Case Study 1 at different prediction times; (a) signal 1-2 at prediction times t=20, 50, and 60 s, and (b) signal 2-4 at prediction times. T=35, 45, and 70 s.

FIG. 8 illustrates T-SNE results from Case Study 1 of real and synthetic data generated by multiple methods.

FIG. 9 illustrates the MAE, mean error, and error spread for five different methods in Case Study 1: (a) the prediction errors from FPT to EOP and (b) the prediction errors from the first time V_{0.2ω-fs/2}^{RMS}>0.17 ips to EOP. The error bars indicate mean±one standard deviation.

FIG. 10 illustrates the RUL prediction results and the degradation curve for bearing 3-2 in Case Study 2.

FIG. 11 illustrates the predicted feature values at selected prediction times for bearing 3-2 in Case Study 2.

FIG. 12 is a reliability plot showing the variation of the observed confidence level against the expected confidence level in Case Study 2.

FIG. 13 is a flowchart illustrating one example of a method.

FIG. 14 is a block diagram of a sensor module.

### DETAILED DESCRIPTION

The lack of run-to-failure data has been one of the challenges in developing and practically implementing robust prognostics models for predicting remaining useful life (RUL) in industrial equipment. This disclosure includes a new Generative Adversarial Network (GAN) based prognostics method for RUL prediction. We disclose a novel joint training strategy to integrate the training process of a health predictor within the GAN architecture. GAN uses available time series degradation data to generate synthetic degradation data that enhances the predictor's learning and forecast performance, thus improving the RUL prediction accuracy. We demonstrate the utility and performance of the disclosed method through two examples. The first numerical toy case study of forecasting polynomial-like time series shows that the disclosed Jointly Trained Health Predictor (HP-JT) method produces smaller one- and multi-step ahead prediction errors than a traditional health predictor (HP). In the second case study, we design a cross validation study utilizing an open-source bearing dataset to evaluate the model's performance in RUL prediction. Compared to HP, the disclosed method decreases the bearing RUL prediction average error by 29.4% in a five-fold cross-validation study. We further compare the model with standard data augmentation techniques such as adding noise and using a variational autoencoder (VAE). The results from the case studies show that the disclosed method can generate time series representing the real-data distribution.

### 1. Introduction

While the disclosed Jointly Trained Health Predictor (HP-JT) method can be generally applied to predicting the remaining useful life of almost any type of industrial equipment, for the sake of understandability this application will focus on the embodiment of this disclosure as applied to the prediction of remaining useful life in rolling element bearings.

As one of the most common and critical components in rotating machines, rolling element bearings play a crucial part in rotating machinery. The primary purpose of using a bearing is to prevent direct metal-to-metal contact between rotating components, friction, heat generation, and the wear and tear of parts (Lei et al., 2018; Wang et al., 2017; Zhang et al., 2017). The unexpected failure of the bearing may severely affect the adjacent machine components, leading to abrupt plant shutdown, financial loss, and even catastrophic accidents (Hu et al., 2019; Liu et al., 2018; J. Wu et al., 2018). Therefore, accurate prediction of bearing remaining useful life (RUL) improves productivity and reduces maintenance costs. A general bearing failure prognostic methodology comprises four essential processes: data acquisition, health indicator construction, health stage division, and RUL prediction (Lei et al., 2018).

The process of data acquisition collects sensor signals that reflect bearing health stages. Many different types of sensors, such as those that capture vibration (Guo et al., 2017; Wang, 2012; Wu et al., 2017), acoustic emissions (Aye & Heyns, 2017; Motahari-Nezhad & Jafari, 2021), and temperatures (Ren et al., 2017), have been applied to bearing failure prognostics. However, vibration sensors are most commonly used for bearing health monitoring due to their sensitivity and widespread availability.

Higher-level features (called health indicators), which are computed from acquired sensory data, are metrics that reflect the health states of the bearing. The construction of a good health indicator is pivotal for failure prognostics and can simplify the modeling of the degradation process and increase RUL prediction accuracy. Health indicators can be categorized into physics-based and virtual health indicators. Generally, physics-based health indicators are extracted from a raw signal using signal processing methods like Hilbert-Huang transforms (Soualhi et al., 2014), Kurtosis values (Zhang et al., 2015), and root mean square (RMS) values (Malhi et al., 2011). RMS is one of the most widely used physics-based health indicators. Virtual health indicators are constructed by fusing multiple physics-based health indicators or multi-sensor signals. For example, Wang (2012) used principal component analysis to fuse multiple features and Ren et al. (2018) extracted features from the time domain, frequency domain, and time-frequency domain, then adopted an autoencoder to construct the health indicator. One limitation of virtual health indicators is that virtual health indicators lack physical meaning and only present a virtual description of the degradation trends of the target bearings (Lei et al., 2018).

Any computed health indicator could help divide the health stages of a bearing by identifying when bearing degradation starts. Typically, a bearing is healthy at the early stage of its life, where health indicator values do not change significantly. After the formation of a bearing fault, a bearing will start to degrade, and the bearing state transforms from a healthy stage into a degradation stage. Most failure prognostics approaches focus on the degradation stage, where an obvious trend can be observed in the health indicator values. Thus, most prognostics models are trained using available degradation data prior to being used to predict the RUL of a bearing.

RUL prediction approaches can be broadly classified into two categories based on the type of model: (a) model-based and (b) data driven. Model-based approaches construct mathematical models by analyzing the bearing degradation mechanisms (Cubillo et al., 2016). Nowadays, model-based approaches such as the Paris-Erdogan model (Lei et al., 2016), the particle filter (Jouin et al., 2016), the Eyring model (Saxena et al., 2008), and the exponential model (Li et al., 2015) have been well applied to predict the general trend of degradation. However, these model-based approaches require accurate estimation of the model parameters. Unfortunately, since rotating machinery has several different working settings, building a mathematical model that fits all the possible working conditions is challenging. Additionally, if there is a change in an operating condition, the prediction results of model-based approaches tend to become less accurate and not reliable (Liu et al., 2021).

On the other hand, data-driven approaches typically employ machine learning techniques to extract and learn the patterns from the available observations without utilizing any knowledge of the degradation mechanisms (Wu et al., 2020). In this regard, several well-known machine learning algorithms, such as Gaussian process regression (Panet al., 2016), support vector machines (Lei, 2012), and artificial neural networks (Xue et al., 2020), have been implemented.

In the past few years, deep learning techniques have also attracted widespread attention. Yoo and Back (2018) used wavelet transform analysis extract the time-frequency features from vibration data and then a convolutional neural network (CNN) was employed to estimate bearing RUL. Guo et al. (2017) selected model input by looking at the correlation and monotonicity of extracted features, then developed a recurrent neural network (RNN) for RUL prediction. As a special type of recurrent neural network, long short-term memory (LSTM) has become a powerful tool in extracting temporal information for bearing failure prognostics (Y. Wu et al., 2018).

Other variants of deep learning models have also been applied for bearing prognostics. For example, Chen et al. (2020) adopted the attention mechanism into the LSTM network to adaptively select features that are important for RUL prediction, resulting in accurate prediction results. Zhu et al. (2018) adopted a multiscale convolutional neural network, which keeps the global and local information synchronously to enhance the prediction performance.

Based on the output of a predictive model, data-driven approaches for bearing prognostics can be sorted into two types: 1) direct mapping approaches (Cheng et al., 2021; Zhu et al., 2018); and 2) forecasting approaches (He et al., 2022; Shi & Chehade, 2021). The direct mapping approaches take the raw signal or constructed health indicator values as input and produce an RUL estimate as output. The forecasting approaches take the historical health indicator values as the input, forecast the future degradation trajectory of the health indicator values until the failure threshold is reached, then calculate the RUL.

Although data-driven approaches have shown promising results, they often face the following challenges:

Many data-driven approaches map the model input with the RUL directly. However, it has been previously shown that the degradation process of the bearing is nonlinear (Sadoughi et al., 2019; Wang et al., 2016). During the early stage of many run-to-failure tests, bearings are healthy and do not show any significant change in the collected vibration data. Only after a certain period of operation can bearing related faults be detected and a degradation trend observed. In addition, the degradation rate at which two similar bearings approach failure can be highly nonlinear with a computed health indicator, so directly mapping extracted features to the RUL can produce nonphysical results that do not ensure RUL convergence as the bearing approaches failure.

Additionally, data-driven approaches heavily rely on a large amount of training data to acquire degradation information, and it can be time consuming, costly, and often impossible to gather a large amount of bearing run-to failure data. Data augmentation is one way to alleviate this problem, by generating synthetic training data. Some commonly used approaches have been well applied, such as adding noise and extending or shrinking the run-to-failure data that exists. The core of data augmentation is to ensure that generated data is similar to the original data, not only in terms of magnitude but also in data distribution.

In this regard, the generative adversarial network has attracted wide attention recently. GAN has been used in several fields to generate high-quality synthetic data for data augmentation, where traditional data augmentation methods do not yield good results. The implementation of GAN-based data augmentation has been applied to solve a variety of engineering problems, including but not limited to: (1) image classification (Abdelhalim et al., 2021; Frid-Adar et al., 2018; Shorten & Khoshgoftaar, 2019), (2) electroencephalography signal classification (Hatamian et al., 2020; Luo et al., 2020), and (3) time series anomaly detection (Li et al., 2019; Lim et al., 2018). Many of these referenced researchers compared GAN-based data augmentation with conventional data augmentation approaches and demonstrated the GAN-based approach delivers significant improvement in model performance, such as sensitivity and prediction accuracy.

This disclosure proposes a GAN-based LSTM predictor for predicting remaining useful life (RUL) in industrial equipment. Specifically, a Jointly Trained Health Predictor (HP-JT) method is disclosed to forecast the future behavior of a set of higher-level health indicators that are computed from raw sensor data. In order to best explain this method, we demonstrate an application using real bearing run-to-failure data, and we also devise a toy problem to mimic a simplified bearing degradation behavior. We compare the disclosed HP-JT method with other data augmentation methods, such as adding noise and using a variational autoencoder (VAE). Our main contributions are summarized as follows:

1. We put a heavy emphasis on computing valuable higher-level features (health indicators) that can improve predictions. For exemplary purposes, we define a bearing health indicator that measures bearing health based on the root mean square values in the velocity domain. This definition complies with ISO 10816, which we also referred to in defining the threshold for bearing failure (Eshleman & Nagle-Eshleman, 1999; ISO 10816-3:2009, 2021). The disclosed HP-JT method is demonstrated by forecasting this health indicator (by marching in time) until the failure threshold is reached.

2. To deal with the challenge of insufficient training data, we develop a GAN-based data augmentation method by integrating HP-JT into the GAN architecture and then proposing a joint training strategy. The performance of HP-JT is boosted by acquiring knowledge from both training data and synthetic data.

The remainder of this disclosure is organized as follows. Section 2 introduces the disclosed framework and the models used for comparison. Section 3 includes two case studies to evaluate the disclosed method. Finally, a summary and conclusions are presented in section 4.

### II. HP-JT Prognostics Method

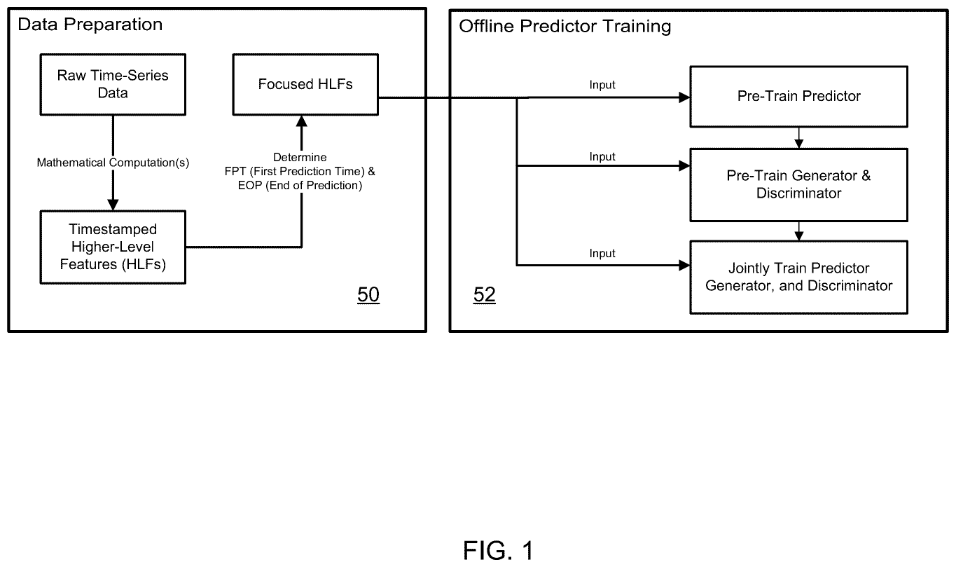

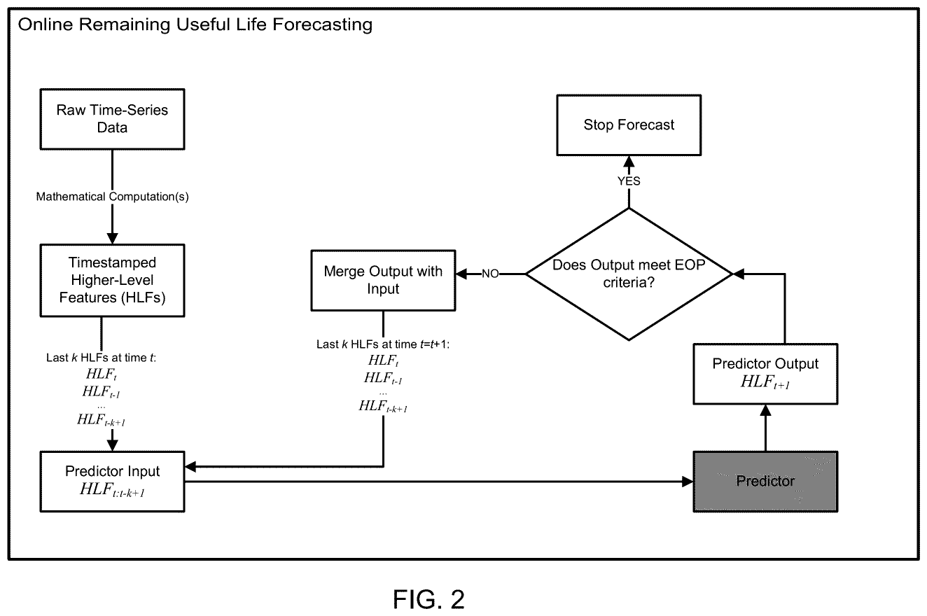

The disclosed HP-JT prediction method relies on three different stages to predict the remaining useful life of industrial equipment. The first two (data preparation and offline predictor training) are illustrated in FIG. 1 and the last (online RUL prediction) is illustrated in FIG. 2. Detailed discussions of these three stages are presented in sections 2.1, 2.2, and 2.3. In section 2.4, we introduce benchmark models for comparison.

### 2.1. Data Preparation

As seen in FIG. 1, the first stage of the disclosed HP-JT method (data preparation) is a process that converts raw sensor training inputs into higher-level features that better represent the health condition of the equipment being monitored. It also defines the first time-history data point (FTP) in a given training dataset to be used for prediction as well as identifying the time-history data point (EOP) at which the monitored equipment has reached end-of-life. While this data preparation step can vary significantly between applications, in the exemplary application of the HP-JT method to predicting bearing failure, data preparation entails calculating the root-mean-squared (RMS) value of a sub-band filtered velocity signal and using this as a higher-level health indicator.

Most run-to-failure datasets available for predicting the RUL of bearings use vibration signals in the acceleration domain obtained from accelerometers. However, the industrial-relevant ISO standards define end-of-life based on feature values in the velocity domain (ISO 10816-3:2009, 2021). This is because the amplitude of acceleration changes dramatically depending on the frequency of shaft rotation. In contrast, the amplitude of the signal in the velocity domain provides a more stable representation regardless of shaft tuning speed. In the disclosed method, the acceleration signal is first converted into the velocity domain by performing numerical integration. To avoid interference from low-frequency noise and to obtain the frequency information that reflects the bearing damage severity as much as possible, the velocity RMS in the frequency range

$$0.2 ω - \frac{{f}_{s}}{2} Hz$$

is extracted, where ω denotes shaft frequency and fₛ denotes the sampling frequency. The RMS values of the time series are obtained from its Fourier transform spectrum using Parseval's theorem (Nussbaumer, 1981), written as:

$${V}_{0.2 ω - \frac{{f}_{s}}{2}}^{RMS} = \sqrt{{\sum }_{f = 0.2 ω}^{\frac{{f}_{s}}{2}} \frac{{\vert V ( f ) \vert}^{2}}{2}} \qquad ( 1 )$$

where V(f) is the single-side frequency spectrum for v(t). To improve the reliability of the extracted features, we also apply a moving average method. In this exemplary application, the smoothed health indicator value is the average of the current observation with two previous observations from the recent past.

In the exemplary application of the disclosed method, a 2σ approach is used to locate the first prediction time (FPT). Training data collected at an early stage are considered healthy with a calculated feature mean (μ) and standard deviation. Using these values, a baseline threshold of (μ+2σ) is set on the feature value. The FPT is then obtained when two consecutive observations

$$( {V}_{0.2 ω - \frac{{f}_{s}}{2}}^{RMS} )$$

exceed the threshold.

In the exemplary application of the disclosed method, the End of Prediction (EOP) time of the bearing is then obtained when

$${V}_{0.2 ω - \frac{{f}_{s}}{2}}^{RMS}$$

reaches a given threshold. Following the ISO 10816 alarm threshold for medium-sized motors, we define the failure threshold value as 0.27 ips (ISO 10816-3:2009, 2021).

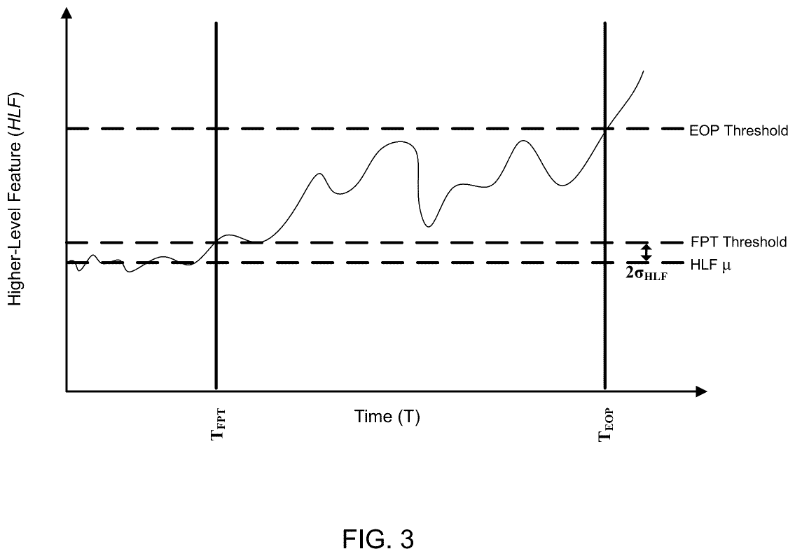

The development of an FPT and EOP for a typical RUL prediction using the disclosed method is illustrated in FIG. 3. Before the FPT, the monitored equipment is healthy, with random fluctuations of the computed higher-level features (HLF). After the FPT, the monitored equipment is in a degradation stage, and the computed HLFs increase along with the deterioration of the equipment until these HLFs reach a failure threshold, which denotes the EOP.

### 2.2. Offline Predictor Training

As seen in FIG. 1, the second stage of the disclosed HP-JT method (offline predictor training) consists of sending prepared data from the first stage (data preparation) as input to a three-step process in which a Predictor, Generator, and Discriminator are pre-trained and then jointly trained.

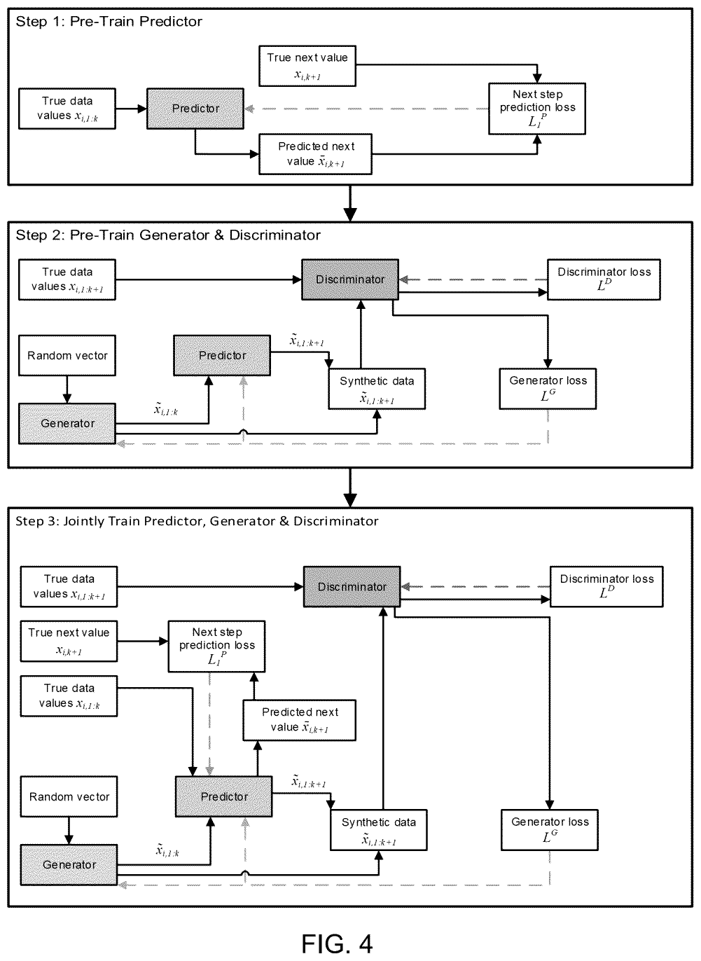

The disclosed HP-JT predictor is formed by an LSTM layer followed by a dense layer. As shown in FIG. 4, the first step of offline predictor training is to pre-train the HP-JT predictor. The input of the HP-JT is the higher-level feature values starting from the previous k−1 timesteps to the current time. The output of the predictor model is the higher-level feature value at the next time step. In this step, the mean squared error loss is adopted to optimize the parameters of the predictor.

After pre-training the HP-JT, the second step of offline predictor training utilizes a GAN to generate synthetic data to boost the performance of the HP-JT model. A traditional way of performing GAN-based data augmentation is to use training data to train the GAN, and then to combine GAN-generated synthetic data with the training data to form augmented training data for model training. Here, different from that traditional GAN-based data augmentation, a joint GAN training approach was designed, integrating the HP-JT predictor into the GAN architecture.

Each of the generator, the HP-JT predictor, and the discriminator contribute to synthetic data generation. The generator's output is noise when it is initialized. To guarantee the HP-JT acquires degradation knowledge from synthetic data, we fix the parameters of the HP-JT after it has been pretrained and then pre-train the generator and discriminator before all the GAN-LSTM components are jointly trained.

The architecture of the disclosed generator and discriminator pre-training is shown in the second step of FIG. 4. The generator takes a random vector of length k and outputs a vector with the same length. The generated vector \tilde{x}_{i,1:k} is then fed into the HP-JT predictor to predict the value at the next time step. The predicted next-step value is then attached to the generator's output to get synthetic data. The discriminator then takes the synthetic and real data as input and identifies the input as real or fake.

During this pre-training, the discriminator and generator are optimized iteratively. For the training of discriminator, the loss function is composed of two pieces: 1) the real data is classified correctly, and 2) the synthetic data is classified as fake data. The discriminator loss function is written as:

$${L}^{D} = - \frac{1}{n} {\sum }_{i = 1}^{n} [ log D ( {x}_{i , 1 : k + 1} ) + log ( 1 - D ( {\tilde{x}}_{i , 1 : k + 1} ) ) ] \qquad ( 2 )$$

where n represents the number of training samples, x_{i,1:k+1} is the ith real data point with length=k·D(x_{i,1:k+1}) denotes the output of the discriminator with input as x_{i,1:k+1}. \tilde{x}_{i,1:k+1} is the ith synthetic data with length=k, which is generated by concatenating the output of the generator (\tilde{x}_{i,1:k+1}) with the output of the predictor (\tilde{x}_{i,1:k+1}). The objective of the discriminator training is to minimize L^{D} so that the discriminator can correctly identify the input data as real or fake.

For each epoch during the pre-training of the generator and discriminator, after the discriminator is optimized, the training of the generator begins by fixing the parameters of the discriminator. The objective of the generator training is to make the discriminator classify synthetic data as real data. The generator loss function is written as:

$${L}^{G} = \frac{1}{n} {\sum }_{i = 1}^{n} log ( 1 - D ( {\tilde{x}}_{i , 1 : k + 1} ) ) \qquad ( 3 )$$

The training of generator and discriminator can be interpreted as a two-player game in which the discriminator tries to identify the generated signal from all the inputs, and the generator tries to generate synthetic data that can fool the discriminator. Conceptually, the training of GAN corresponds to a minimax two-player game written as (Goodfellow et al., 2020):

$${min}_{G} {max}_{D} L ( D , G ) = \frac{1}{n} {\sum }_{i = 1}^{n} [ log D ( {x}_{i , 1 : k + 1} ) + log ( 1 - D ( {\tilde{x}}_{i , 1 : k + 1} ) ) ] \qquad ( 4 )$$

The third step of the offline predictor training process, as shown in FIG. 4, is to jointly train the HP-JT predictor, the generator, and the discriminator simultaneously. Each joint training epoch consists of two sub-steps. In the first sub-step, the HP-JT predictor learns from every iteration of synthetic data while providing better next-step prediction. This next-step prediction is then involved in the training of the generator and the discriminator. In other words, the three components now enhance the performance of each other. We note that joint training works only after pre-training the GAN components on real data, without which the predictor would focus its learning on the random data provided by the generator. In the second sub-step, the predictor is fine-tuned using real data. The pre-training and fine-tuning together ensure a general direction of learning is achieved, which is further enhanced during joint training.

The architecture of the disclosed generator, discriminator, and predictor used in the exemplary application of prediction bearing RUL is shown in Table 1. Here, the generator consists of three fully connected layers; the ReLU activation function is adopted to prevent negative synthetic signal values. The discriminator consists of four fully connected layers. The discriminator needs to output classification probabilities; therefore, the Sigmoid activation function is adopted at the last fully connected layer. And the disclosed HP-JT is formed by an LSTM layer followed by a fully connected layer.

TABLE 1
The structure of the disclosed GAN-LSTM network.

| Module name | Layer | Output shape, Activation |
|---|---|---|
| Generator | Input | (Samples, 20) |
| | Fully Connected | (Samples, 64), Linear |
| | Fully Connected | (Samples, 32), Linear |
| | Fully Connected | (Samples, 20), ReLU |
| Discriminator | Input layer | (Samples, 21) |
| | Fully Connected | (Samples, 64), Linear |
| | Fully Connected | (Samples, 128), ReLU |
| | Fully Connected | (Samples, 64), ReLU |
| | Fully Connected | (Samples, 1), Sigmoid |
| HP-JT | Input | (Samples, 20, 1) |
| | LSTM | (Samples, 60), Tanh |
| | Fully Connected | (Samples, 1), Linear |

### 2.3. Online RUL Prediction

Once trained, the HP-JT predictor can be used to forecast higher-level health indicator values until an EOP failure threshold is reached, as seen in FIG. 2. With the current time step as t_{current}, the higher-level health indicator values from the previous k−1 time steps to the current time constitute the model input, and the model predicts the health indicator value at the next time step. The model output is then concatenated to the original input, and the model is reevaluated by marching in time to forecast the feature value until the model output exceeds the predefined T_{EOP} threshold at time T_{EOL} (see FIG. 3). The predicted RUL can be determined by:

$$RUL ( t ) = {T}_{EOL} - {t}_{current} \qquad ( 5 )$$

### 2.4. Benchmark Models

Four commonly used methods are briefly introduced as benchmark models that can be compared against the disclosed approach. The models are a) Health Predictor (HP), b) HP-Noise, c) HPVAE, and d) quadratic regression model. In section 3, we compare the performance of the disclosed HP-JT against the four benchmark methods.

In the HP method, we use the predictor without being integrated into the GAN as a baseline model. It has the same architecture as the HP-JT and is only trained on real data.

We also want to compare the disclosed method against other data augmentation approaches. To do that, we include the predictor trained with a simple data augmentation method, which we refer to as HP-Noise. Here, synthetic data is generated by adding a certain Gaussian noise to the real data. The training dataset of HP-Noise is composed of synthetic and real data. The HP-Noise model also has the same architecture as the HP-JT model.

Besides GAN, VAE is another powerful deep generative model for data augmentation (Huang et al., 2021). The HP-VAE method is composed of two steps. First, the VAE is trained to provide synthetic data following a similar pattern to the training data. Then, the data generated by VAE are combined with the real data to train the predictor. The detailed configuration of HP-VAE is included in Table 2.

TABLE 2
The specific configuration of HP-VAE.

| Module name | Layer | Output shape, Activation |
|---|---|---|
| Encoder | Input | (Samples, 21) |
| | Fully connected | (Samples, 16), Linear |
| | Fully connected | (Samples, 12), ReLU |
| Decoder | Input | (Samples, 6) |
| | Fully connected | (Samples, 16), Linear |
| | Fully connected | (Samples, 21), ReLU |
| HP-VAE | Input | (Samples, 20, 1) |
| | LSTM | (Samples, 60), Tanh |
| | Fully connected | (Samples, 1), Linear |

The quadratic regression model is a simple mathematical model that captures the degradation trend by fitting a quadratic model to the feature values. The model is defined as:

$$HLF ( t ) = {m}_{1} {t}^{2} + {m}_{2} t + {m}_{3} \qquad ( 6 )$$

where HLF (t) represents the higher-level health indicator value at time t, and m₁, m₂, m₃ are the model parameters that are optimized during regression using real data. The ordinary least square method fits the model in eqn. (6) using the current and previous k−1 measurements. After the model parameters, m₁, m₂, m₃, are determined, followed by the prediction of the future health indicator values, RUL is calculated by measuring the time when the predicted health indicator reaches a predefined threshold. A certain RUL prediction will be deemed unreliable in the quadratic regression model if the resulting forecast values are monotonically decreasing and thus do not reach an EOP threshold. In such cases, the model takes the nearest reliable RUL result minus the time difference between that prediction and current times as the predicted RUL.

### III. Exemplary Case Studies

Two case studies are employed to demonstrate the effectiveness of the disclosed method. Case study 1 is a numerical toy problem that evaluates the model's performance in predicting future values. Case study 2 is a practical example, using publicly available Xi'an Jiaotong University and Changxing Sumyong Technology Co., Ltd. (XJTU-SY) bearing dataset to verify the performance of the disclosed method by considering the RUL prediction accuracy through a 5-fold cross validation. The performance of the disclosed method in uncertainty estimation is analyzed in section 3.3.

### 3.1. Case Study 1: Time Series Prediction of a Toy Problem

### 3.1.1. Experimental Setting

A numerical toy problem is defined to mimic a simplified behavior of bearing degradation. In this case study, two types of trend functions are defined based on the bearing degradation patterns (Lei et al., 2018):

Quadratic degradation trend:

$$\begin{matrix}{S}_{Quadratic} ( t ) = {a}_{1} {t}^{3} + {b}_{1} {t}^{2} + w & 0 \leq t \leq T\end{matrix} \qquad ( 7 )$$

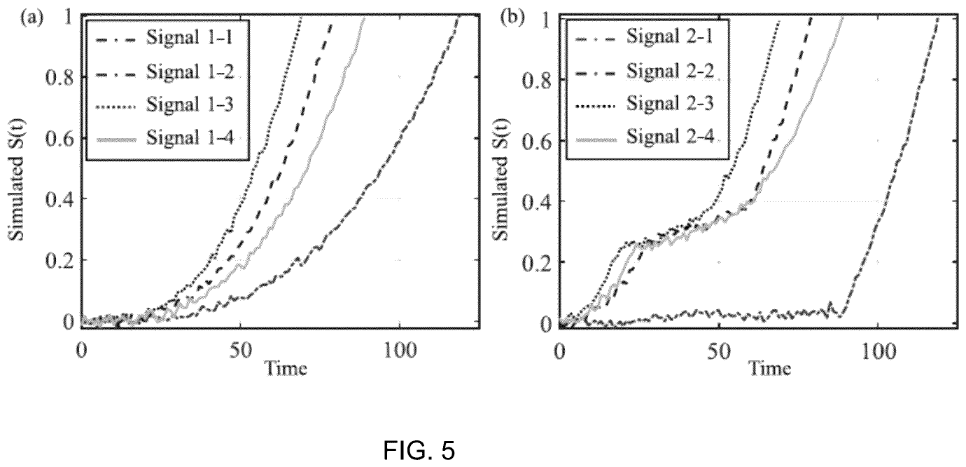

Three-stage degradation trend:

$${S}_{Three - stage} ( t ) = \{ \begin{matrix}{a}_{2} {t}^{3} + {b}_{2} {t}^{2} + {c}_{2} + w & 0 \leq t < {t}_{1} \\ {a}_{3} {t}^{3} + {b}_{3} {t}^{2} + {c}_{3} + w & {t}_{1} \leq t < {t}_{2} \\ {a}_{4} {t}^{3} + {b}_{4} {t}^{2} + {c}_{4} + w & {t}_{2} \leq t < T\end{matrix} \qquad ( 8 )$$

where aᵢ, bᵢ and cᵢ (i=1, 2, 3) are the coefficients of the degradation trends, and w is Gaussian noise. The signal generated by the quadratic degradation function represents a monotonically increasing trend. The three-stage degradation function generates the signal where the rate of degradation is significant during the early stages (due to the formation of the defect) followed by its decrease (due to smoothening effect) and an increase close to EOP. This behavior is similar to the degradation processes with multiple stages summarized in (Lei et al., 2018). Eight simulated signals are generated by following eqns. (7) and (8) are illustrated in FIG. 5.

A cross-validation study was conducted using the simulated signals. For each cross-validation experiment, one signal was selected as the test data, and the other seven were used to train the model. In this case study, the predictor takes the signal values of current and previous k−1 time steps to forecast the value for the next Nₛ steps. The HP-JT model was compared with HP, HP-Noise, and HP-VAE. After a preliminary optimization study, the learning rates for the HP, HP-Noise, and HP-VAE models were set as 0.00015. The learning rate for the HP-JT model is also set to 0.00015, with the learning rates of both the generator and discriminator fixed at 0.0001.

Given a test signal with a total length of T_{signal}, we look at all the forecasts beginning from t=k+1 to the last possible forecast of length Nₛ at t=T_{signal}−Nₛ. The RMSEs of all the forecasts are combined into a single evaluation metric, written as:

$${RMSE}_{signal} = \sqrt{\frac{1}{{T}_{signal} - {N}_{s} - k + 1} \frac{1}{{N}_{s}} {\sum }_{t = k}^{{T}_{signal} - {N}_{s}} {\sum }_{i = 1}^{{N}_{s}} {( {S}_{t}^{P} ( i ) - {S}^{T} ( t + i ) )}^{2}} \qquad ( 9 )$$

where Sₜ^{P} represents the i^{th} predicted value from the prediction time t, S^{T}(t+i) represents the true value at time t+i.

### 3.1.2. Results

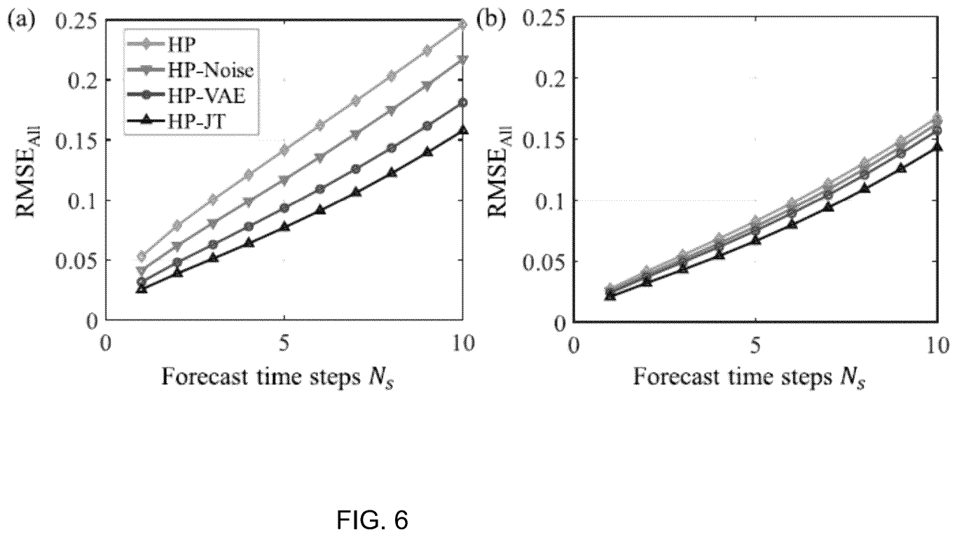

An eight-fold cross-validation test was conducted for the eight signals, and the RMSE over all the prediction results was calculated (RMSE_{All}). FIG. 6 shows the variation of RMSE_{All} with the number of predicted steps Nₛ with 50 and 200 training epochs, respectively. For both numbers of epochs, the HP-JT model produced the least RMSE_{All} value when forecasting Nₛ=1 to Nₛ=10 steps.

All the data augmentation methods enhanced the RSME of the predictions compared to the HP model, with HP-VAE outperforming the HP-Noise. Note that HP-JT yields the best prediction RMSE for all forecast steps.

For the remainder of this case study, we attempt to explain how the disclosed method outperforms other data augmentation techniques. For comparison, all the models were trained with a total training epoch of 200. HP-JT is pre-trained for 30 epochs, followed by joint training with 170 epochs.

To show the forecasting capability of all the methods, we show the RMSE values for the one-step-ahead (Nₛ=1) and five-step-ahead (Nₛ=5) predictions in Table 3. Among eight cross-validation experiments, the HP-JT produced the least RMSE_{All} value. On average, HP-JT outperformed 23.5%, 17.6%, and 13.7% for Nₛ=1, 19.6%, 15.2%, and 11.2% for Nₛ=5 compared to HP, HP-Noise, and HP-VAE, respectively. Note that, compared with the quadratic degradation signals, there is a noticeable increase in the RMSE_{signal} value for the three-stage degradation signals given the more complicated health degradation structure, especially for signal 2-1.

TABLE 3
Prediction results by HP-JT and benchmark models.

| | | RMSE(×10⁻²) | | | | | | | |
|---|---|---|---|---|---|---|---|---|---|
| | | N_{S} = 1 | | | | N_{S} = 5 | | | |
| | Degradation | | HP- | HP- | HP- | | HP- | HP- | HP- |
| Signal ID | type | HP | Noise | VAE | JT | HP | Noise | VAE | JT |
| 1-1 | Quadratic | 2.16 | 1.20 | 1.31 | 1.08 | 6.15 | 3.42 | 3.73 | 2.84 |
| 1-2 | degradation | 1.53 | 1.32 | 1.20 | 1.19 | 4.25 | 3.77 | 3.19 | 3.30 |
| 1-3 | | 2.02 | 1.80 | 1.56 | 1.51 | 6.42 | 5.78 | 4.84 | 4.65 |
| 1-4 | | 1.36 | 1.38 | 1.25 | 1.30 | 3.68 | 3.79 | 3.18 | 3.55 |
| 2-1 | Three stage | 3.89 | 3.85 | 3.48 | 2.68 | 11.93 | 11.86 | 10.81 | 8.84 |
| 2-2 | degradation | 3.23 | 3.06 | 3.01 | 2.88 | 10.96 | 10.53 | 10.61 | 10.06 |
| 2-3 | | 2.97 | 2.85 | 2.98 | 2.66 | 9.83 | 10.11 | 10.17 | 9.54 |
| 2-4 | | 2.34 | 2.31 | 2.31 | 1.98 | 7.49 | 7.29 | 7.44 | 6.43 |
| RMSE_{All} | | 2.64 | 2.45 | 2.34 | 2.02 | 8.26 | 7.83 | 7.48 | 6.64 |

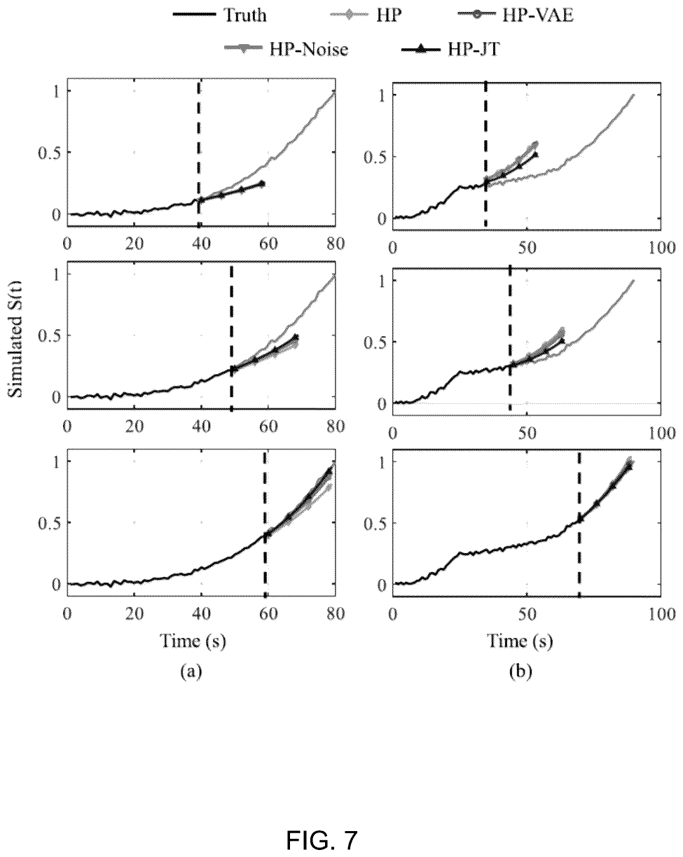

To further investigate the superior performance of HP-JT, the 20-step-ahead forecast results of the four models for two representative signals 1-2 and 2-4 at three different prediction times are shown in FIG. 7. For the simple quadratic signal 1-2, all four predictor models achieved satisfactory predicting accuracy, yet the augmented data models slightly outperformed HP. However, for the more complicated signal 2-4, the HP-JT outperforms the benchmark models in the forecast, especially for time steps right after the second stage (from t=25 to 60 min). As we get further away from the second stage, HP-JT starts to perform similarly to the benchmark models as the signal starts to follow a simpler trend.

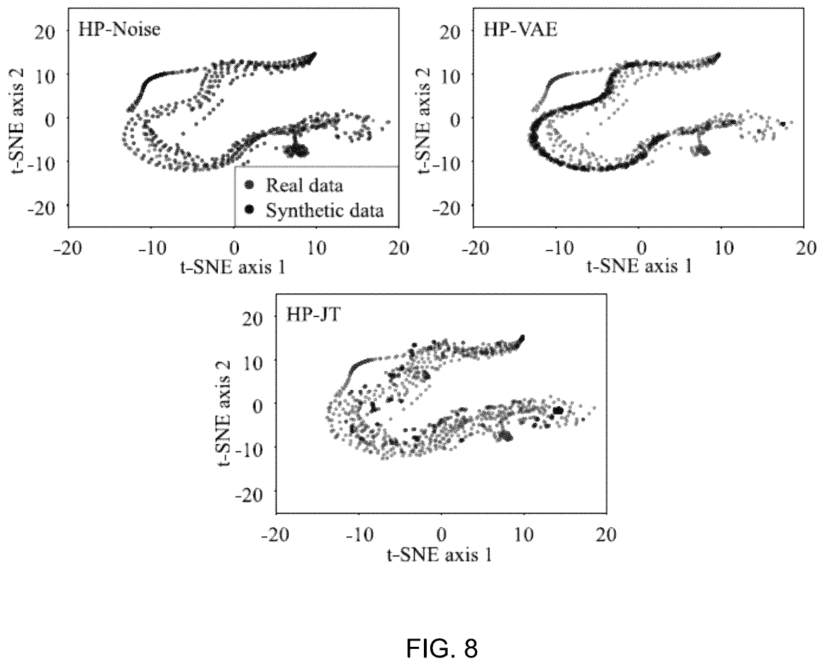

To investigate the reduction in average RMSE of the RUL, the t-Distributed Stochastic Neighbor Embedding (t-SNE) analysis (Van der Maaten & Hinton, 2008) was performed to visualize the similarity between real and synthetic data generated with adding noise, VAE and HPJT. The t-SNE results for each data augmentation method are shown in FIG. 8, with the total training epochs of 200 and signal 2-4 as the test data.

The HP-Noise method augments the data by adding Gaussian noise to the training data; thus, the data points only shift slightly and maintain the original distribution. Therefore, this slightly shifted distribution does not add enough new information to generate novel data for training in the case of limited available data. HP-VAE was partially successful in mimicking the global trend of the real-data distribution; however, its restriction to Gaussian distribution modeling limited the generated data distribution to only partially represent the real data distribution resulting in little improvement. On the other hand, the data generated by HP-JT follows the global distribution and captures the local variations of the real-data distribution. Unlike HP-Noise, HP-JT is not limited to individual data points' immediate neighborhood, thus creating novel yet representative synthetic data.

In the case of HP-JT, the synthetic data generated by the GAN-LSTM network changes during every epoch of pre-training and joint training to encompass the entire distribution of the training dataset.

To further explore the benefits of joint training strategy over static data augmentation, we study another model called HP-noJT that uses fixed synthetic data without joint training. The HP-noJT was initialized using the same parameters as that of the pre-trained HP-JT predictor, with the difference being that there is no joint training in the training procedure of HP-noJT. The synthetic data was combined with the original training data to train the model. In other words, the HP-noJT predictor only learns the original training data and the static synthetic data generated after the pre-training of the generator. On the other hand, during joint training in HP-JT, the generator is also simultaneously trained with the HP-JT predictor. As an effect of training the generator, slightly different synthetic data is generated at every epoch, which the HP-JT model also secs. In other words, the HP-JT model learns from different synthetic data at each joint train epoch, whereas the HP-noJT predictor was trained using fixed synthetic data.

The prediction results of HP-noJT are summarized in Table 4. HpnoJT performs better than LSTM (Table 3) by 9.1% RMSE_{All} for one-step-ahead prediction. This observation proves that using synthetic data enhanced the accuracy of the next-step prediction. The HP-JT, however, outperforms HP-noJT by 15.8% in one-step-ahead (Nₛ=1) prediction and by 13.1% in five-step-ahead (Nₛ=5) prediction, respectively. The data generated at each epoch may contain some unreliable samples that are different from the real data. The HP-noJT may be forced to learn these unreliable samples during the training process. For HP-JT, the generated sample changed at each epoch, preventing the predictor from memorizing unreliable samples. The integration of the predictor and GAN architecture helps improve the generality of the HPJT model, which leads to the least average RMSE error among all the tests.

TABLE 4
Prediction results by HP-noJT.

| Signal ID | Degradation type | N_{S} = 1 | N_{S} = 5 |
|---|---|---|---|
| 1-1 | Quadratic Degradation | 1.18 | 3.21 |
| 1-2 | | 1.39 | 3.68 |
| 1-3 | | 1.72 | 5.49 |
| 1-4 | | 1.38 | 3.76 |
| 2-1 | Three-Stage Degradation | 3.56 | 11.15 |
| 2-2 | | 2.92 | 10.19 |
| 2-3 | | 3.14 | 10.59 |
| 2-4 | | 2.42 | 7.64 |
| RMSE_{All} | | 2.40 | 7.64 |

### 3.2. Case Study 2: Bearing RUL Prediction

### 3.2.1. Experimental Setting

We now evaluate the performance of the disclosed method aimed at RUL prediction using the publicly available XJTU-SY dataset. The XJTUSY dataset provides run-to-failure data collected from 15 rolling element bearings (Wang et al., 2018). The vibration data can be divided into three groups based on the operating condition, shown in Table 5.

The bearings were affected by the radial load; therefore, the data collected from the x-axis (horizontal direction) is more obvious (Kundu et al., 2019). In this case study, the x-axis vibration data were used to extract higher-level V_{0.2ω-fs/2}^{RMS} values for RUL prediction. These computed values represent the RMS velocity in the frequency range between 0.2ω and fₛ/2 Hz, where ω denotes the shaft turning frequency and fₛ denotes the sampling frequency. The feature value of the most recent k=20 measurements was used in forecasting V_{0.2ω-fs/2}^{RMS} to a failure threshold of 0.27 and thus determine the RUL.

TABLE 5
XJTU-SY bearing dataset.

| | Operating condition | | |
|---|---|---|---|
| | Condition (1) | Condition (2) | Condition (3) |
| Radial load | 12 kN | 11 kN | 10 kN |
| Speed | 35 Hz | 37.5 Hz | 40 Hz |
| Bearing ID | 1-1 | 2-1 | 3-1 |
| | 1-2 | 2-2 | 3-2 |
| | 1-3 | 2-3 | 3-3 |
| | 1-4 | 2-4 | 3-4 |
| | 1-5 | 2-5 | 3-5 |

We conducted a five-fold cross-validation study on the XJTU-SY dataset where the 15 bearings were divided into five folds, with each fold containing data collected from three different working conditions:
Fold-1: Bearings 1-1, 2-1, and 3-1
Fold-2: Bearings 1-2, 2-2, and 3-2
Fold-3: Bearings 1-3, 2-3, and 3-3
Fold-4: Bearings 1-4, 2-4, and 3-4
Fold-5: Bearings 1-5, 2-5, and 3-5

The disclosed HP-JT model was compared with benchmark models presented in section III. The input length of the generator, HP-JT, and discriminator were set at 20, 20, and 21, respectively. The learning rate of the HP-JT was set as 0.001, and the learning rate of both generator and discriminator was 0.0001. The HP-JT was pre-trained for 60 epochs. The generator and discriminator were pre-trained for 1000 epochs. Finally, the joint training of all the GAN-LSTM components was performed for 60 epochs.

Similar to case study 1, the HP and HP-Noise models had the same architecture as the HP-JT. The learning rates and the training epochs of those two models were set to 0.001 and 120, respectively. Note that HPJT only gets optimized during the pre-training and joint training. Therefore, the total training epoch of the HP-JT is equal to the predictor trained by other methods (HP, HP-Noise, and HP-VAE).

The RMSE of RUL prediction results (from t_{FPT} to t_{EOP}) was used as an evaluation metric that measures the prediction error, written as:

$${RMSE}_{RUL} = \sqrt{\frac{1}{( {t}_{EOP} - {t}_{FPT} + 1 )} {\sum }_{t = {t}_{FPT}}^{{t}_{EOP}} {( {RUL}_{pred} ( t ) - {RUL}_{true} ( t ) )}^{2}} \qquad ( 10 )$$

where t_{FPT} is the time when prognostics starts, and RUL_{pred}(t) and RULₜᵣᵤₑ(t) are the predicted and true RUL at time step t, respectively.

### 3.2.2. Results

The RUL prediction results for all the test bearings, as a result of the five-fold cross-validation, are summarized in Table 6. The bearings are sorted in ascending order of the total prognostic duration ΔT, defined as ΔT=t_{EOL}−t_{FPT}+1. For each bearing in Table 6, the model with the least prediction error is highlighted in bold. The cumulative RMSE_{RUL} is calculated by doing a weighted average of the individual bearing RMSE_{RUL} scaled by ΔT. Overall, the disclosed HP-JT produces better RUL prediction accuracies with 40.3%, 29.4%, 26.8%, and 20.4% improvement in RMSE error compared to the quadratic regression, HP, HP-Noise, and HP-VAE models. Note that for bearings 2-4, 3-5, 3-3, 1-5, and 1-4, the number of time steps in the prognostic time period is smaller than the selected input length of the LSTM predictor (k=20 min). For these bearings, data points before t_{FPT} were used as input, and these data do not provide enough prognostic information for making accurate predictions. Also, for most tests, the disclosed HP-JT model outperformed other methods with bearings that have a longer prognostic time.

TABLE 6
RUL prediction results by HP-JT and benchmark models

| | | RMSE | | | | |
|---|---|---|---|---|---|---|
| | | Quadratic | | HP | HP- | HP- |
| Bearing ID | ΔT(min) | regression | HP | Noise | VAE | JT |
| 2-4 | 4 | 13.18 | 13.26 | 4.74 | 25.46 | 24.39 |
| 3-5 | 6 | 6 | 13.47 | 4.18 | 15.73 | 10.89 |
| 3-3 | 10 | 8.93 | 14.91 | 7.35 | 9.58 | 21.99 |
| 1-5 | 16 | 60.06 | 22.97 | 13.49 | 37.72 | 30.93 |
| 1-4 | 17 | 36.04 | 42.66 | 22.05 | 33.38 | 48.43 |
| 2-1 | 34 | 9.70 | 5.3 | 10.14 | 18.61 | 42.59 |
| 1-2 | 42 | 16.17 | 13.91 | 13.21 | 7.97 | 12.83 |
| 1-1 | 43 | 13.70 | 15.71 | 14.4 | 27.36 | 9.04 |
| 3-2 | 46 | 33.07 | 12.2 | 10.9 | 9.27 | 4.89 |
| 3-4 | 60 | 16.37 | 8.23 | 12.99 | 11.98 | 12.6 |
| 2-5 | 77 | 38.10 | 11.72 | 13.36 | 15.64 | 17.41 |
| 2-3 | 83 | 20.20 | 15.74 | 25.12 | 28.17 | 9.93 |
| 1-3 | 91 | 45.73 | 25.59 | 31.12 | 32.38 | 20.37 |
| 2-2 | 105 | 58.77 | 43.99 | 43.56 | 33.97 | 29.69 |
| 3-1 | 124 | 35.16 | 53.84 | 47.29 | 36.52 | 21.25 |
| Cumulative^{#} | | 36.70 | 31.00 | 29.91 | 27.50 | 21.90 |

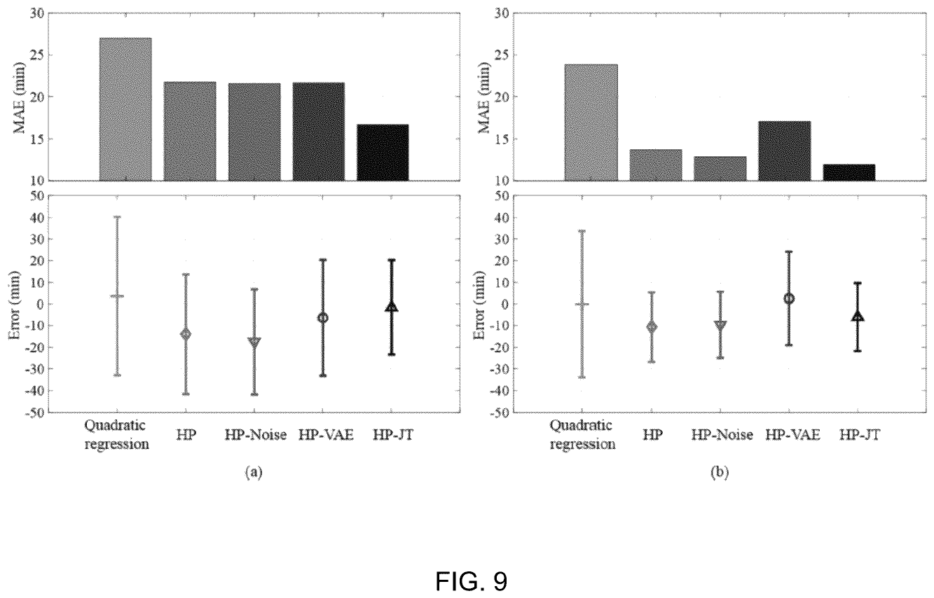

To better compare the prediction results, we analyze the mean absolute error (MAE) that quantifies the magnitude of the prediction error, and also include the mean error that quantifies the overall direction of the prediction error (overestimation or underestimation). At the same level of prediction accuracy, underestimating the bearing RUL is often more desirable than overestimating it in industry settings because overestimation brings misleading confidence to the end user and may cause unexpected machine failure. FIG. 9(a) summarizes the MAE and mean error of RUL prediction by various models. The MAE of quadratic regression, HP, HP-Noise, and HP-VAE are 23.84, 21.77, 21.62, and 21.68 min, respectively. HP-JT yields the least MAE, 16.70 min. Compared to quadratic regression, the four health predictor models (i.e., HP, HP-Noise, HP-VAE, and HP-JT) predict RUL with smaller mean errors that are all less than zero (i.e., underestimating the RUL on average).

At an early stage of degradation,

$${V}_{0.2 ω - \frac{{f}_{s}}{2}}^{RMS}$$

of a bearing tends not to change significantly. As a result, the RUL predictions at this stage may contain larger errors than those when the bearing is close to failure. Suppose we only consider the samples from the time when

$${V}_{0.2 ω - \frac{{f}_{s}}{2}}^{RMS}$$

first exceeds 0.17 ips to EOP and we label these samples as the late-stage degradation samples. The prediction errors on these samples are shown in FIG. 9(b). The MAE and error spread both decrease for all the five methods. Excluding the HP-JT model, the HP-Noise model produces the lowest MAE. A paired t-test is conducted to analyze the mean difference between the prediction errors of HP-JT and HP-Noise. The null hypothesis in the paired t-test is the mean difference between the prediction errors by HP-JT and HP-Noise is zero. The p-value is 2.26×10⁻¹⁶<<0.001, which provides strong evidence against the null hypothesis. Thus, HP-JT yields a significantly different mean error compared to HP-Noise. As the mean error of HP-JT is closer to zero and its MAE is smaller, HP-JT on average archives higher accuracy than HPNoise as well as the other three models.

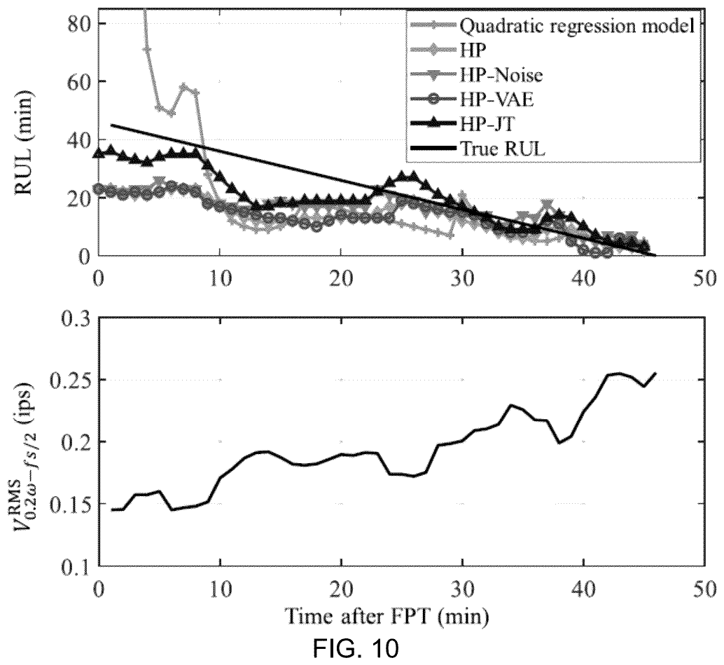

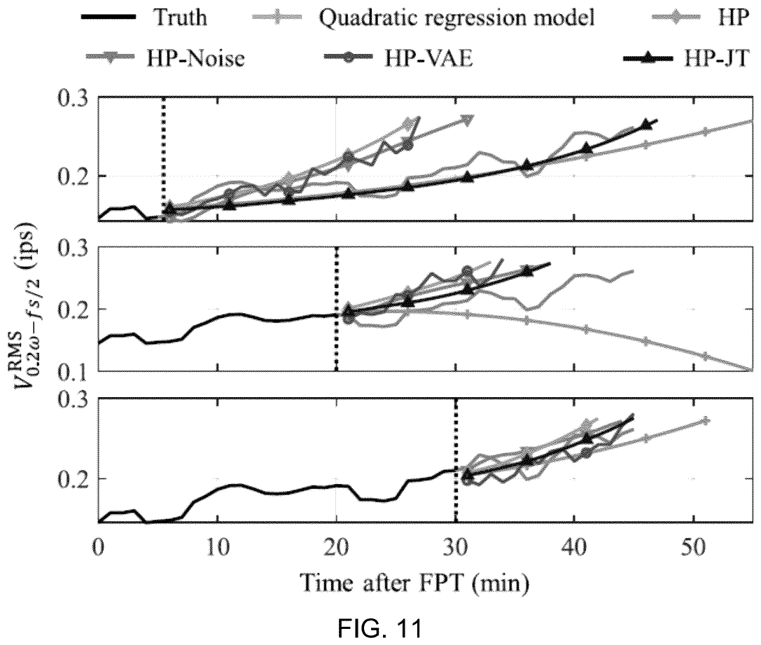

FIG. 10 shows a typical predicted RUL and the corresponding higher-level V_{0.2ω-fs/2}^{RMS} values for test bearing 3-2. Note that in the early stages of the bearing degradation, the HP-JT provided the most accurate results compared to the benchmark models. The quadratic regression model yielded the least accurate. As the bearing degradation progressed with time, the extracted feature became closer to the failure threshold and made RUL prediction easier with cumulative multi-step-ahead prediction error. This led to similar RUL prediction results across all the approaches. To further investigate the results, the predicted feature values generated by all the comparative models at three different prediction times are shown in FIG. 11. The HP-JT model predicted the degradation trend most accurately, especially at the onset of bearing degradation. Note that, at time t=20 min there is almost no change in the amplitude of input features, yet HP-JT successfully provides the most accurate result. The accuracy of the disclosed method can be attributable to the quality of the synthetic training data where both global and local novel features are generated. Note that HP, HP-Noise, and HP-VAE tend to underestimate the RUL, which indicates not being able to distinguish between local and global trends. The quadratic model is the most sensitive to the local trends as it only relies on information provided by recent local observations. If the local trends follow the global trend, it can provide accurate results as in the top plot. Otherwise, the results are unreliable, as in the middle plot of FIG. 11.

### 3.3. Performance of the Disclosed Method in Uncertainty Estimation

The models presented thus far are deterministic. Now, we explore the forecasting performance of HP-JT when considering uncertainty. The two major types of uncertainty are aleatoric uncertainty and epistemic uncertainty. Aleatoric uncertainty is irreducible uncertainty in the training data, which can be estimated by treating the model output as a distribution. Epistemic uncertainty is the uncertainty that occurs due to inadequate knowledge and data. Epistemic uncertainty can be reduced by having more training data. In the case of bearing prognostics, building a probabilistic model could help capture the aleatoric uncertainty of the data. And the use of data augmentation techniques such as HP-JT should theoretically provide a more reliable measure of epistemic uncertainty.

One way to build a probabilistic model is to treat the model output to obey a Gaussian distribution by adding a Gaussian layer as the model's last layer (Nemani et al., 2021). This added layer estimates both the mean μ(x) and variance σ²(x) of the Gaussian output. For a perfectly trained model, the output μ(x) is close to the true value y, and σ²(x) accounts for the uncertainty of the output. The negative log-likelihood (NLL) criterion is used to train the model with the Gaussian layer:

$$- longp ( {y}_{n} \vert {x}_{n} ) = \frac{long {σ}^{2} ( x )}{2} + \frac{{( y - μ ( x ) )}^{2}}{2 {σ}^{2} ( x )} + constant \qquad ( 11 )$$

For the bearing prognostic implementation in case study 2, the performance of HP-JT was compared against the HP model. To construct a probabilistic model, we replaced the HP-JT's last layer (dense layer) with a Gaussian layer. During the joint training of the HP-JT, the μ(\tilde{x}_{i,k+1}) output was concatenated with \tilde{x}_{i,1:k} to form synthetic data (\tilde{x}_{i,1:k+1}).

After the model was trained, the predictor estimates the bearing RUL following a similar procedure described in section 2. The time when next-step prediction

$$μ ( {HI}_{Input} = {V}_{0.2 ω - \frac{{f}_{s}}{2}}^{RMS} )$$

reaches the threshold (V_{cutoff}) is marked as μ_{RUL} and the time when μ(HIᵢₙₚᵤₜ)+σ²(HIᵢₙₚᵤₜ) reaches the threshold defined equal to μ_{RUL}−σ_{RUL}².

The reliability curve is used to evaluate the model's performance in uncertainty estimation. The reliability curve displays the predicted fraction of points in each confidence interval relative to the expected fraction of points in that interval (Roman et al., 2021). Given a dataset {x_{Tp,1:k+1}, RUL_{T}_{ₚ}}, Tₚ=1, . . . , Tₜₒₜₐₗ. At each prediction time Tₚ, the probabilistic model provides a Gaussian distribution N(μ_{RUL}, σ_{RUL}). We choose m confidence levels 0≤p₁<p₂< . . . <pₘ≤100; for each threshold pⱼ we compute the observed confidence level:

$${\hat{p}}_{j} = \frac{{\sum }_{{T}_{p} = 1}^{{T}_{total}} {F}_{{T}_{p}} ( {μ}_{RUL} , {σ}_{RUL}^{2} , {p}_{j} )}{{T}_{total}} \times 100 \qquad ( 12 )$$

where F_{T}_{ₚ} is a function that classifies whether the true RUL_{T}_{ₚ} lies within a predefined interval. If the RUL_{T}_{ₚ} lies below the pⱼ-th quantile of the produced Gaussian distribution N (μ_{RUL}, σ_{RUL}), then we have FT, (μ_{RUL}, σ_{RUL}, pⱼ)=1; otherwise, FTP (μ_{RUL}, σ_{RUL}, pⱼ)=0. The set {(pⱼ, pⱼ)}=1 forms a reliability curve.

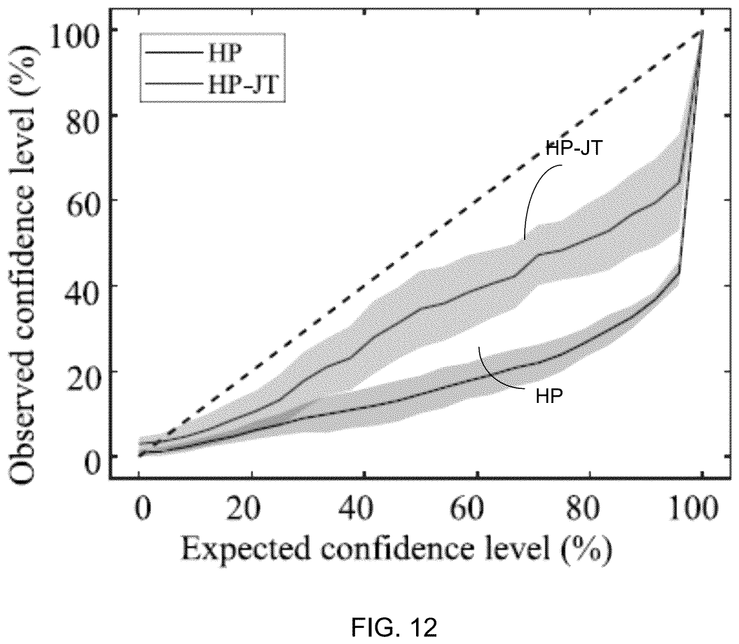

In FIG. 12, we compare the uncertainty estimation performance of the probabilistic HP-JT method and a simple probabilistic HP method for the case study 2 dataset. A total of five models are trained for each method to show run-to-run variation. The reliability of an ideal model falls on the black dashed line where the model is neither underconfident nor overconfident. Both HP and HP-JT are shown to be overconfident in their RUL predictions. However, the reliability curves produced by the HP-JT model are closer to the dashed line (the ideal case), meaning that the observed confidence level is overall closer to the expected confidence level. This means that the HP-JT provides more reliable uncertainty estimations of RUL.

### 4. Review and Conclusions

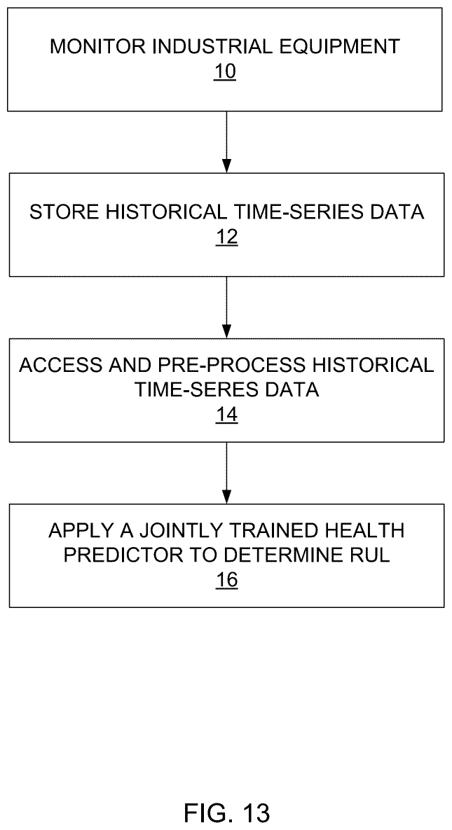

FIG. 13 illustrates one example of the methodology disclosed which may use time-series data to predict RUL of industrial equipment in cases where limited time-series training data is available. In step 10, industrial equipment is monitored in order to sense historical time-series data associated with the industrial equipment using at least one sensor. Various types of sensors may be used depending upon the industrial equipment being used including, without limitation, temperature sensors, pressure sensors, flow sensors, level sensors, pH sensors, conductivity sensors, humidity sensors, proximity sensors, vibration sensors, infrared sensors, ultrasonic sensors, gas sensors, oxygen sensors, turbidity sensors, force sensors, accelerometers, light sensors, current sensors, voltage sensors, position sensors, speed sensors, color sensors, tilt sensors, moisture sensors, displacement sensors, torque sensors, optical sensors, smoke detectors, dust sensors, strain gauges, magnetic field sensors, rotary encoders, tachometers, hall effect sensors, resolvers, gyroscopes, potentiometers, contact sensors. Note that some sensors may be used to sense environmental parameters associated with the industrial equipment. Some sensors may be used to directly sense parameters of interests. Some sensors may be used to indirectly sense parameters of interest.

In step 12, the method provides for storing the historical time-series data from the at least one sensor. The storing may take place in a memory such as a memory of a sensor module or a memory of another computing device. In step 14, the method provides for accessing the historical time-series data and pre-processing the historical time-series data to extract higher-level features associated with the remaining useful life of the industrial equipment. This may be performed at a computing device either at the sensor or remote from the sensor.

In step 16, the method provides for applying a jointly trained health predictor to the higher-level features using a computing device by executing a set of instructions from a non-transitory machine-readable memory using a processor of the computing device to determine a prediction for the remaining useful life of the industrial equipment. The jointly trained health predictor may be trained using real data and augmented with generated data such as previously described where a Generative Adversarial Network (GAN) is used. The jointly trained predictor may include a neural network layer. The neural network layer may be a long short-term memory (LSTM) layer.

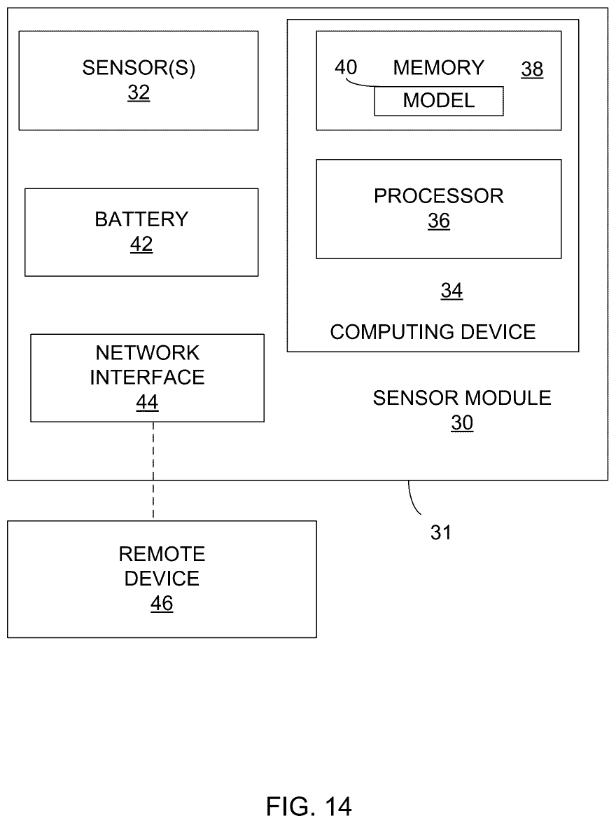

FIG. 14 illustrates an example of a sensor module 30. The sensor module 30 may be used to perform the method of FIG. 13 in order to predict remaining useful life of industrial equipment in an industrial environment. The sensor module 30 may include a sensor housing 31 which may be configured to be positioned and/or attached at an appropriate location relative to the industrial equipment or within the industrial environment. The sensor module 30 may include a processor 36 disposed within the sensor housing 31, and at least one sensor 32 for sensing machine data for the industrial equipment, the at least one sensor 32 operatively connected to the processor 36. The processor 36 is configured to extract higher-level features associated with the remaining useful life of the industrial equipment from the machine sensor data and apply a jointly trained health predictor to the higher-level features using a computing device 34 by executing a set of instructions from a non-transitory machine-readable memory 38 using a processor 36 of the computing device 34 to determine a prediction for the remaining useful life of the industrial equipment. The jointly trained health predictor may be trained using physically acquired data and augmented with generated data. The generated data may be generated using a Generative Adversarial Network (GAN). The jointly trained health predictor may include a neural network layer which may be a long short-term memory (LSTM) layer.

The sensor module 30 may include a network interface 44 which allows the sensor module 30 to communicate with a remote device 46. For example, the network interface 44 may be an ethernet network interface, a Controller Area Network (CAN) interface, a Bluetooth interface, or other type of wired or wireless network interface suitable for the industrial environment in which the industrial equipment operates. The sensor module 30 may further include a battery 42 disposed within the sensor module 30 to allow the sensor module to function independently from other power sources.

Thus, as shown and described, the disclosure provides a novel HP-JT method for forecasting health condition for industrial equipment such as a bearing health condition and predicting the remaining useful life for the industrial equipment. Based on results of the experimental data for the toy problem mimicking simplified bearing failure behavior and using a publicly available XJTU-SY bearing dataset we demonstrate the functionality of this approach. We find that the GAN-LSTM architecture adds significant diversity to the training data while maintaining the original training data distribution instead of other data augmentation techniques such as adding noise and using VAE, which tend to mimic a local distribution of the training data. This leads to better learning of the long-term dependencies by the HP-JT model, leading to the lowest average RMSE in forecasting the time series for the toy problem. For the XJTU data set, the HP-JT method achieves a 29.4% reduction in RMSE and a 25% reduction in MAE compared to the HP method. Also, the prediction error distribution indicates that the disclosed method provides more accurate and conservative RUL prediction than the other methods used for comparison. The training of the disclosed method requires more computational time relative to the benchmark methods; however, since in the industrial implementation, machine health assessments are carried out periodically, the process of bearing RUL prediction is not time-constrained, and thus, the model accuracy is more important than the training time. As long as the model provides higher accuracy, the added training complexity is not as important.

The disclosed HP-JT method can be applied to solve other engineering problems associated with industrial equipment where time series prediction is required and the amount of available training data is limited. These problems include, for example, cutting tool health forecasting, battery capacity forecasting and life prediction, and sales forecasting. In this work, we assume bearing degradation is slow and gradual and does not involve extreme, short-term damage leading to sudden failure. However, it is contemplated that extreme cases may be monitored and users may be alerted to their occurrence, as opposed to applying the method for slow, gradual degradation trajectories.

### REFERENCES

1. Abdelhalim, I. S. A., Mohamed, M. F., & Mahdy, Y. B. (2021). Data augmentation for skin lesion using self-attention based progressive generative adversarial network. Expert Systems with Applications, 165, Article 113922.
2. Aye, S. A., & Heyns, P. (2017). An integrated Gaussian process regression for prediction of remaining useful life of slow speed bearings based on acoustic emission. Mechanical Systems and Signal Processing, 84, 485-498.
3. Barzegar, V., Laflamme, S., Hu, C., & Dodson, J. (2021). Multi-time resolution ensemble 1stms for enhanced feature extraction in high-rate time series. Sensors, 21 (6), 1954.
4. Chen, Z., Wu, M., Zhao, R., Guretno, F., Yan, R., & Li, X. (2020). Machine remaining useful life prediction via an attention-based deep learning approach. IEEE Transactions on Industrial Electronics, 68 (3), 2521-2531.
5. Cheng, H., Kong, X., Chen, G., Wang, Q., & Wang, R. (2021). Transferable convolutional neural network based remaining useful life prediction of bearing under multiple failure behaviors. Measurement, 168, Article 108286.
6. Cubillo, A., Perinpanayagam, S., & Esperon-Miguez, M. (2016). A review of physics-based models in prognostics: Application to gears and bearings of rotating machinery. Advances in Mechanical Engineering, 8 (8), 1687814016664660.
7. Eshleman, R. L., & Nagle-Eshleman, J. (1999). Basic machinery vibrations: An introduction to machine testing, analysis, and monitoring. VIPress.
8. Frid-Adar, M., Diamant, I., Klang, E., Amitai, M., Goldberger, J., & Greenspan, H. (2018). GAN-based synthetic medical image augmentation for increased CNN performance in liver lesion classification. Neurocomputing, 321, 321-331.
9. Goodfellow, I., Pouget-Abadie, J., Mirza, M., Xu, B., Warde-Farley, D., Ozair, S., . . . . Bengio, Y. (2020). Generative adversarial networks. Communications of the ACM, 63 (11), 139-144.
10. Guo, L., Li, N., Jia, F., Lei, Y., & Lin, J. (2017). A recurrent neural network based health indicator for remaining useful life prediction of bearings. Neurocomputing, 240, 98-109.
11. Hatamian, F. N., Ravikumar, N., Vesal, S., Kemeth, F. P., Struck, M., & Maier, A. (2020). The effect of data augmentation on classification of atrial fibrillation in short single-lead ECG signals using deep neural networks. ICASSP 2020-2020 IEEE International Conference on Acoustics, Speech and Signal Processing (ICASSP).
12. He, R., Tian, Z., & Zuo, M. J. (2022). A semi-supervised GAN method for RUL prediction using failure and suspension histories. Mechanical Systems and Signal Processing, 168, Article 108657.
13. Hu, C.-H., Pei, H., Si, X.-S., Du, D.-B., Pang, Z.-N., & Wang, X. (2019). A prognostic model based on DBN and diffusion process for degrading bearing. IEEE Transactions on Industrial Electronics, 67 (10), 8767-8777.
14. Huang, Y., Tang, Y., & Vanzwieten, J. (2021). Prognostics with Variational Autoencoder by Generative Adversarial Learning. IEEE Transactions on Industrial Electronics.
15. ISO 10816-3:2009. (2021). @isostandards.https://www.iso.org/standard/50528.html.
16. Jouin, M., Gouriveau, R., Hissel, D., P′era, M.-C., & Zerhouni, N. (2016). Particle filter-based prognostics: Review, discussion and perspectives. Mechanical Systems and Signal Processing, 72, 2-31.
17. Kim, S., Kim, N. H., & Choi, J.-H. (2020). Prediction of remaining useful life by data augmentation technique based on dynamic time warping. Mechanical Systems and Signal Processing, 136, Article 106486.
18. Kundu, P., Darpe, A. K., & Kulkarni, M. S. (2019). Weibull accelerated failure time regression model for remaining useful life prediction of bearing working under multiple operating conditions. Mechanical Systems and Signal Processing, 134, Article 106302.
19. Lei, Y., Li, N., Gontarz, S., Lin, J., Radkowski, S., & Dybala, J. (2016). A model-based method for remaining useful life prediction of machinery. IEEE Transactions on Reliability, 65 (3), 1314-1326.
20. Lei, Y., Li, N., Guo, L., Li, N., Yan, T., & Lin, J. (2018). Machinery health prognostics: A systematic review from data acquisition to RUL prediction. Mechanical Systems and Signal Processing, 104, 799-834.
21. Lei, Z. (2012). Fault prognostic algorithm based on multivariate relevance vector machine and time series iterative prediction. Procedia engineering, 29, 678-686.
22. Li, D., Chen, D., Jin, B., Shi, L., Goh, J., & Ng, S.-K. (2019). MAD-GAN: Multivariate anomaly detection for time series data with generative adversarial networks.
23. International Conference on Artificial Neural Networks.
24. Li, N., Lei, Y., Lin, J., & Ding, S. X. (2015). An improved exponential model for predicting remaining useful life of rolling element bearings. IEEE Transactions on Industrial Electronics, 62 (12), 7762-7773.
25. Lim, S. K., Loo, Y., Tran, N.-T., Cheung, N.-M., Roig, G., & Elovici, Y. (2018). Doping: Generative data augmentation for unsupervised anomaly detection with gan. 2018 IEEE International Conference on Data Mining (ICDM).
26. Liu, H., Mo, Z., Zhang, H., Zeng, X., Wang, J., & Miao, Q. (2018). Investigation on rolling bearing remaining useful life prediction: A review. 2018 Prognostics and System Health Management Conference (PHM-Chongqing).
27. Liu, L., Song, X., Chen, K., Hou, B., Chai, X., & Ning, H. (2021). An enhanced encoder-decoder framework for bearing remaining useful life prediction. Measurement, 170, Article 108753.
28. Lu, H., Barzegar, V., Nemani, V. P., Hu, C., Laflamme, S., & Zimmerman, A. T. (2021). GAN-LSTM predictor for failure prognostics of rolling element bearings. 2021 IEEE International Conference on Prognostics and Health Management (ICPHM).
29. Lu, H., Barzegar, V., Nemani, V. P., Hu, C., Laflamme, S., & Zimmerman, A. T. (2021). Joint training of a predictor network and a generative adversarial network for time series forecasting: A case study of bearing prognostics. Experts Systems with Applications 203 (2002) 117415.
30. Lu, Y., Li, Q., Pan, Z., & Liang, S. Y. (2018). Prognosis of bearing degradation using gradient variable forgetting factor RLS combined with time series model. IEEE Access, 6, 10986-10995.
31. Luo, Y., Zhu, L.-Z., Wan, Z.-Y., & Lu, B.-L. (2020). Data augmentation for enhancing EEG-based emotion recognition with deep generative models. Journal of Neural Engineering, 17 (5), Article 056021.
32. Malhi, A., Yan, R., & Gao, R. X. (2011). Prognosis of defect propagation based on recurrent neural networks. IEEE Transactions on Instrumentation and Measurement, 60 (3), 703-711.
33. Motahari-Nezhad, M., & Jafari, S. M. (2021). Bearing remaining useful life prediction under starved lubricating condition using time domain acoustic emission signal processing. Expert Systems With Applications, 168, Article 114391.
34. Nemani, V. P., Lu, H., Thelen, A., Hu, C., & Zimmerman, A. T. (2021). Ensembles of Probabilistic LSTM Predictors and Correctors for Bearing Prognostics Using Industrial Standards. Neurocomputing.
35. Nussbaumer, H. J. (1981). The fast Fourier transform. In Fast Fourier Transform and Convolution Algorithms (pp. 80-111). Springer.
36. Pan, D., Liu, J.-B., & Cao, J. (2016). Remaining useful life estimation using an inverse Gaussian degradation model. Neurocomputing, 185, 64-72.
37. Ren, L., Cui, J., Sun, Y., & Cheng, X. (2017). Multi-bearing remaining useful life collaborative prediction: A deep learning approach. Journal of Manufacturing Systems, 43, 248-256.
38. Ren, L., Sun, Y., Cui, J., & Zhang, L. (2018). Bearing remaining useful life prediction based on deep autoencoder and deep neural networks. Journal of Manufacturing Systems, 48, 71-77.
39. Roman, D., Saxena, S., Robu, V., Pecht, M., & Flynn, D. (2021). Machine learning pipeline for battery state-of-health estimation. Nature Machine Intelligence, 3 (5), 447-456.
40. Ruder, S. (2016). An overview of gradient descent optimization algorithms. arXiv preprint arXiv: 1609.04747.
41. Sadoughi, M., Lu, H., & Hu, C. (2019). A Deep Learning Approach for Failure Prognostics of Rolling Element Bearings. 2019 IEEE International Conference on Prognostics and Health Management (ICPHM).
42. Saxena, A., Goebel, K., Simon, D., & Eklund, N. (2008). Damage propagation modeling for aircraft engine run-to-failure simulation. 2008 international conference on prognostics and health management.
43. Shi, Z., & Chehade, A. (2021). A dual-LSTM framework combining change point detection and remaining useful life prediction. Reliability Engineering & System Safety, 205, Article 107257.
44. Shorten, C., & Khoshgoftaar, T. M. (2019). A survey on image data augmentation for deep learning. Journal of big data, 6 (1), 1-48.
45. Soualhi, A., Medjaher, K., & Zerhouni, N. (2014). Bearing health monitoring based on Hilbert-Huang transform, support vector machine, and regression. IEEE Transactions on Instrumentation and Measurement, 64 (1), 52-62.
46. Van der Maaten, L., & Hinton, G. (2008). Visualizing data using t-SNE. Journal of machine learning research, 9 (11).
47. Wang, B., Lei, Y., Li, N., & Li, N. (2018). A hybrid prognostics approach for estimating remaining useful life of rolling element bearings. IEEE Transactions on Reliability, 69 (1), 401-412.
48. Wang, D., Tsui, K.-L., & Miao, Q. (2017). Prognostics and health management: A review of vibration based bearing and gear health indicators. IEEE Access, 6, 665-676.
49. Wang, T. (2012). Bearing life prediction based on vibration signals: A case study and lessons learned. 2012 IEEE Conference on Prognostics and Health Management.
50. Wang, Y., Xiang, J., Markert, R., & Liang, M. (2016). Spectral kurtosis for fault detection, diagnosis and prognostics of rotating machines: A review with applications. Mechanical Systems and Signal Processing, 66, 679-698.
51. Wen, Q., Sun, L., Yang, F., Song, X., Gao, J., Wang, X., & Xu, H. (2020). Time series data augmentation for deep learning: A survey. arXiv preprint arXiv: 2002.12478.
52. Wu, B., Li, W., & Qiu, M.-q. (2017). Remaining useful life prediction of bearing with vibration signals based on a novel indicator. Shock and Vibration, 2017.
53. Wu, J., Hu, K., Cheng, Y., Zhu, H., Shao, X., & Wang, Y. (2020). Data-driven remaining useful life prediction via multiple sensor signals and deep long short-term memory neural network. ISA transactions, 97, 241-250.
54. Wu, J., Wu, C., Cao, S., Or, S. W., Deng, C., & Shao, X. (2018). Degradation data-driven time-to-failure prognostics approach for rolling element bearings in electrical machines. IEEE Transactions on Industrial Electronics, 66 (1), 529-539.
55. Wu, Y., Yuan, M., Dong, S., Lin, L., & Liu, Y. (2018). Remaining useful life estimation of engineered systems using vanilla LSTM neural networks. Neurocomputing, 275, 167-179.
56. Xue, Y., Dou, D., & Yang, J. (2020). Multi-fault diagnosis of rotating machinery based on deep convolution neural network and support vector machine. Measurement, 156, Article 107571.
57. Yoo, Y., & Baek, J.-G. (2018). A novel image feature for the remaining useful lifetime prediction of bearings based on continuous wavelet transform and convolutional neural network. Applied Sciences, 8 (7), 1102.
58. Zhang, W., Jia, M.-P., Zhu, L., & Yan, X.-A. (2017). Comprehensive overview on computational intelligence techniques for machinery condition monitoring and fault diagnosis. Chinese Journal of Mechanical Engineering, 30 (4), 782-795.
59. Zhang, Z.-X., Si, X.-S., & Hu, C.-H. (2015). An age- and state-dependent nonlinear prognostic model for degrading systems. IEEE Transactions on Reliability, 64 (4), 1214-1228.
60. Zhu, J., Chen, N., & Peng, W. (2018). Estimation of bearing remaining useful life based on multiscale convolutional neural network. IEEE Transactions on Industrial Electronics, 66 (4), 3208-3216.

What is claimed is:

1. A method for using time-series data to predict remaining useful life of industrial equipment in cases where limited time-series training data is available, the method comprising:
monitoring the industrial equipment to sense historical time-series data associated with the industrial equipment using at least one sensor;
storing the historical time-series data from the at least one sensor;
accessing the historical time-series data and pre-processing the historical time-series data to extract higher-level features associated with the remaining useful life of the industrial equipment; and
applying a jointly trained health predictor to the higher-level features using a computing device by executing a set of instructions from a non-transitory machine-readable memory using a processor of the computing device to determine a prediction for the remaining useful life of the industrial equipment.

2. The method of claim 1 wherein the jointly trained health predictor is trained using real data and augmented with generated data.

3. The method of claim 2 wherein the generated data is generated using a Generative Adversarial Network (GAN).

4. The method of claim 1 wherein the jointly trained health predictor includes a neural network layer.

5. The method of claim 4 wherein the neural network layer is a long short-term memory (LSTM) layer.

6. The method of claim 1 wherein the industrial equipment is comprised of industrial mechanical equipment.

7. The method of claim 1 wherein the industrial equipment comprises a bearing.

8. The method of claim 7 wherein the bearing is a roller element bearing.

9. The method of claim 8 wherein the historical time-series data further comprises shaft rotation speed and loading conditions associated with the roller element bearing.

10. The method of claim 6 wherein the historical time-series data comprises vibration data and the at least one sensor comprises an accelerometer.

11. A sensor module comprising the at least one sensor, the computing device, and the non-transitory machine readable memory and configured for performing the method of claim 1.

12. The sensor module of claim 11 further comprising a battery disposed within the housing and wherein the sensor module is powered by the battery.

13. A sensor module for predicting remaining useful life of industrial equipment in an industrial environment, the sensor comprising:
a sensor housing;
a processor disposed within the sensor housing; and
at least one sensor for sensing machine data for the industrial equipment, the at least one sensor operatively connected to the processor;
wherein the processor is configured to:
extract higher-level features associated with the remaining useful life of the industrial equipment from the machine data;
apply a jointly trained health predictor to the higher-level features using a computing device by executing a set of instructions from a non-transitory machine readable memory using the processor to determine a prediction for the remaining useful life of the industrial equipment.

14. The sensor module of claim 13 wherein the jointly trained health predictor is trained using physically acquired data and augmented with generated data.

15. The sensor module of claim 14 wherein the generated data is generated using a Generative Adversarial Network (GAN).

16. The sensor moule of claim 13 wherein the jointly trained health predictor includes a neural network layer.

17. The sensor module of claim 14 wherein the neural network layer is a long short-term memory (LSTM) layer.

18. The sensor module of claim 13 wherein the industrial equipment comprises a bearing.

19. The sensor module of claim 18 wherein the bearing is a roller element bearing.

20. The sensor module of claim 13 wherein the machine data comprises vibration data and wherein the at least one sensor comprises at least one accelerometer for sensing the vibration data.
